(19) United States
(12) Patent Application Publication
(10) Pub. No.: US 2013/0323367 A1
(43) Pub. Date: Dec. 5, 2013

(54) EXTENDED LIFE FOOD PRODUCT

(71) Applicants: Solene Pont, Hertfordshire (GB); Robin Clifton, Hertfordshire (GB); Tim Fenton, Hertfordshire (GB); Peter Sadd, Hertfordshire (GB); JoAnna Emery, Hertfordshire (GB)

(72) Inventors: Solene Pont, Hertfordshire (GB); Robin Clifton, Hertfordshire (GB); Tim Fenton, Hertfordshire (GB); Peter Sadd, Hertfordshire (GB); JoAnna Emery, Hertfordshire (GB)

(73) Assignee: Premier Foods Group Limited, St. Albans (GB)

(21) Appl. No.: 13/879,331

(22) PCT Filed: Oct. 14, 2011
(86) PCT No.: PCT/GB11/51997

§ 371 Date: Jul. 3, 2013

(30) Foreign Application Priority Data
Oct. 15, 2010 (GB) 1017468.8

(51) Int. Cl. A21D 13/00

(52) U.S. Cl. CPC A21D 13/0025
USPC 426/94; 426/275; 426/241

(57) ABSTRACT

The present invention relates to a food product which is an ambient toastable sandwich with an extended shelf life and which can contain either savoury or sweet fillings As described herein for optimum taste performance the final food product is preferably toasted by the consumer.

The present invention relates to a food product which has an extended shelf life. In particular, the invention relates to an ambient toastable sandwich.

Sandwiches come in a wide variety of forms, ranging from home-made sandwiches to pre-packed, shop-bought sandwiches. Typically, sandwiches are made from two slices of bread stacked one on top of the other, between which is placed one or more fillings to suit the taste of the consumer. The shelf-life of such ‘fresh’ sandwiches is typically determined by the shelf-life of the bread. Such bread, although typically containing preservatives and other ingredients such as humectants etc., generally only has a relatively short shelf life of around 2 weeks before it becomes stale or mouldy. The environment in which the sandwich is stored is also an important factor for shelf-life, and refrigeration is often required to slow bacterial or fungal growth on the bread or filling such that the sandwich is still edible after a week or so. In environments where refrigeration is lacking, or in situations where such refrigeration units fail, often the shelf-life of a typical pre-packed sandwich is severely compromised.

There are a number of long-life' foodstuffs currently available to consumers, which in relation to the present invention typically take the form of a dough-like material with various fillings. Importantly, none of these long-life' foodstuffs use standard bread. Normally a toastable sandwich which contains savoury fillings, such as ham, cheese or beans requires freezing or refrigeration (with a limited shelf life). Further they are made using specialised bread, such as a singular enclosed bread which is injected with filling. Where ambient products do exist, they are generally processed in a variety of ways to achieve their shelf life, such as: (i) by the use of humectants and preservatives; and/or (ii) particular processing of the dough to enable longer shelf-life, such as double-baking processes, etc. Since standard bread is not used for long-life products, there is also the problem that the product does not look like a typical sandwich, and moreover fails to deliver the texture of normal bread.

An example of a well-known long life product is the foodstuff commonly known as Pop Tarts®. This, however, is not a sandwich made of bread, but is a toastable breakfast food consisting of a single piece of pastry with a sweet filling. Furthermore, the product shelf-life is delivered by a combination of added humectants and low moisture.

Another example of a long life product is a vendable sandwich and food product commonly known as Candwich™. This however is a ‘sandwich’ which cannot use standard sandwich bread and must be of certain dimensions to fit within a vendable can.

It can be seen, therefore, that a problem exists in the lack of a foodstuff that is made from bread that is typically used in ‘fresh’ sandwiches, but which is shelf-stable at ambient temperatures for an extended period of time. The present inventors have discovered a way of making such a foodstuff, that has an extended shelf-life and which is palatable for e.g. up to and above 60 days.

In this regard, in one embodiment of the present invention there is provided a sandwich comprising:
at least two regions of bread which encompass at least one filling, each region having a side which faces said filling and a side which does not face said filling,
the sides of the regions of bread which face said filling having incorporated thereon a fatty substance, wherein the fatty substance has between about 4% to about 30% fat content, preferably between about 8 to about 16% fat content, preferably about 16% fat content,
and wherein at least a portion of each of the regions of bread is bonded together to prevent the filling from escaping.

Preferably the sandwich does not contain a distinct additional ingredient that is added specifically to either or both regions of the bread in order to assist bonding of the regions of bread together.

Preferably the fat content of the fatty substance is about 16%, and in some embodiments may be about 8%.

Preferably the fatty substance comprises liquid cheese and/or margarine.

Preferably, the bonding of the regions of bread is completed around substantially all of the periphery of the bread, and more preferably the bonding of the regions of bread is carried out by radio frequency (RF) heat bonding, thereby resulting in an RF heat bond.

In some embodiments of the present invention, the sandwich is contained within a sealed container which may be a toastable pouch.

Most preferably, the sandwich has been subjected to retort whilst in said sealed container, and said sandwich is preferably palatable at 60 days post-manufacture.

In another aspect of the present invention, there is provided a process of making a sandwich, said process comprising the steps of:
applying a fatty substance containing between about 4% to about 30% fat content, preferably between about 8 to about 16% fat content, preferably about 16% fat content to at least one side of a slice of bread, wherein the fatty substance is applied to substantially all of the region of bread that will be in contact with a filling;
applying said filling on top of the fatty substance;
lidding the filling with a second region of bread, where said second region of bread also has applied to it said fatty substance; and
bonding the regions of bread together to form a seal.

Thereafter, the sandwich may optionally be lightly toasted, and in further embodiments it is then packaged in a container, the container is sealed; and the packaged sandwich is then retorted.

Preferably, the fatty substance contains about 16% fat, and in some embodiments may contain about 8% fat.

Preferably the fatty substance is a liquid cheese or margarine.

In some embodiments of the present invention, the step of bonding the regions of bread together is preferably carried out using localised radio frequency heating, and preferably the bond forms a seal around substantially all of the outer region of the pieces of bread.

In yet another embodiment of the present invention, the step of retorting the packaged sandwich is carried out at a pressure of less than about 2 barg. Preferably the pressure does not exceed about 2 barg during the duration of the retort. Optionally, the pressure during the retort sterilisation phase is a varying pressure, ranging from about 1 barg to about 2 barg, preferably from about 1.3 barg to about 1.8 barg, preferably from about 1.3 barg to about 1.6 barg.

In some embodiments of the present invention, the pressure in the come up phase and cooling phase of said retort is varied gradually to prevent damage to said sandwich or sealed package.

In some embodiments, the pressure is gradually increased to the pressure achieved during sterilization over a period of approx. 10 minutes, for example at a rate of approx. 0.1. to 0.2 barg per minute, and/or wherein there begins an immediate gradual reduction in pressure at the end of the sterilization phase over a period of approx 30 minutes to ambient pressure, e.g. at an average rate of approximately 0.05 barg per minute.

Optionally the temperature in the come up phase is gradually and steadily increased to sterilisation temperature from about immediately from the commencement of the retort process, optionally at an average rate of approx. 6° C. per minute for approximately 20 minutes.

In further embodiments, the temperature in the cooling phase is gradually and steadily decreased with a concurrent gradual and steady reduction in the pressure in the retort vessel.

Optionally the pressure during the retort starts to increase from approximately 8 to 13 minutes after the temperature begins to increase, preferably about 9 to 11 minutes after the temperature begins to increase.

In yet further embodiments, the temperature profile of the retort is controlled to prevent damage to the sandwich and/or package, preferably wherein the temperature during the come up phase is increased from ambient to sterilisation temperature over a period of about 20 minutes, with temperature rising continuously during this phase.

Although the retort process has been described above in relation to a packaged sandwich, in yet further embodiments of the present invention the inventive retort process can be used for other applications. In particular, the retort process of the present invention can be used for retorting other foodstuffs that may be susceptible to crushing during a typical retort, but which would benefit from the retort process of the present invention resulting in e.g. improved aesthetics of the foodstuff in question to be more attractive to the consumer.

Thus, in one embodiment of the present invention there is provided a retort process wherein retorting is carried out at a pressure of less than about 2 barg. Preferably the pressure does not exceed about 2 barg during the duration of the retort. Optionally, the pressure during the retort sterilisation phase is a varying pressure, ranging from about 1 barg to about 2 barg, preferably from about 1.3 barg to about 1.8 barg, preferably from about 1.3 barg to about 1.6 barg.

In some embodiments of the present invention, the pressure in the come up phase and cooling phase of said retort is varied gradually to prevent damage to the item(s) being retorted.

In some embodiments, the pressure is gradually increased to the pressure achieved during sterilization over a period of approx. 10 minutes, for example at a rate of approx. 0.1. to 0.2 barg per minute, and/or wherein there begins an immediate gradual reduction in pressure at the end of the sterilization phase over a period of approx 30 minutes to ambient pressure, e.g. at an average rate of approximately 0.05 barg per minute.

Optionally the temperature in the come up phase is gradually and steadily increased to sterilisation temperature from about immediately from the commencement of the retort process, optionally at an average rate of approx. 6° C. per minute for approximately 20 minutes.

In further embodiments, the temperature in the cooling phase is gradually and steadily decreased with a concurrent gradual and steady reduction in the pressure in the retort vessel.

Optionally the pressure during the retort starts to increase from approximately 8 to 13 minutes after the temperature begins to increase, preferably about 9 to 11 minutes after the temperature begins to increase.

In yet further embodiments, the temperature profile of the retort is controlled to prevent damage to the product being retorted, preferably wherein the temperature during the come up phase is increased from ambient to sterilisation temperature over a period of about 20 minutes, with temperature rising continuously during this phase.

There is also provided in the present invention a packaged sandwich as produced according to the processes described herein.

The invention will now be described in more detail. Reference will be made to the accompanying figures, in which:

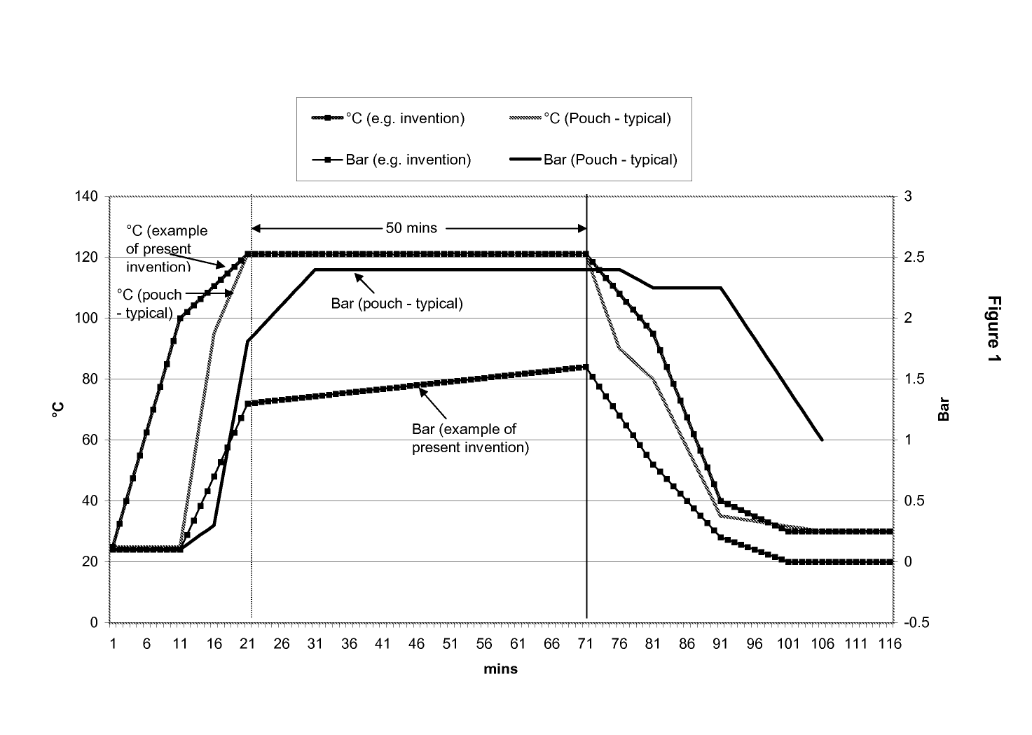

FIG. 1 is a graph depicting typical retort parameters as compared to the retort parameters that may be used in the present invention.

The food product as described in this invention is a sandwich preferably comprising at least two standard slices of the bread typically used in a sandwich, namely square in shape and usually with a crust. However, although there may be advantages associated with a square sandwich, such as ease of bonding slices together during the manufacture of the sandwich, or greater ease of packing the sandwich, the shape of the bread is not a limiting factor of the present invention, and the presence of a crust is optional. The bread may be any of the standard bread types such as white, brown or wholemeal, or mixtures of grains such as can be found in Hovis Best of Both® bread, etc. Speciality bread, such as sourdough or gluten free bread, can also be used, and the skilled person will know of other alternatives.

Preferably, the bread used in the initial stages of making the sandwich of the present invention is fresh. By this, it is meant that the bread is sufficiently soft and elastic for the bonding process (as discussed below) to work in a suitable manner. The bread preferably should not have started to become dried out or stale. More preferably, the bread will not have been frozen prior to use in the sandwich of the present invention. It is believed that the use of frozen bread results in a poor texture post retort.

In the sandwich of the present invention, a layer of a fatty substance is applied onto at least one surface of each slice of bread. This surface will be the surface that forms an inner wall of the sandwich. Preferably, the fatty substance is applied to substantially the whole of the surface of one side of the bread slice. In some embodiments, however, there may be a margin that is left around the outer circumference of the slice of bread that is not coated with the fatty substance. This outer region typically encompasses the crust (if present) and a portion of the non-crust part of the bread.

By ‘fatty substance’ it is meant an edible ingredient (or combination of ingredients) that contain(s) a significant portion of fat or oil as part of its content. The substance can be one that contains various types of fat such as animal or vegetable fat, and may be unsaturated, saturated etc.. The present inventors surprisingly have found that substances with lower fat contents work well in the present invention. A fatty substance containing as little as at least 1% fat by weight is suitable for the present invention. For example, substances with fat contents less than about 50%, preferably ranging from about 4% to 30% fat, preferably from about 6% to about 20% fat, and more preferably from about 8% to about 16% fat. Without wishing to be bound by theory, it is believed that the fatty substance acts as a barrier to migration of the filling into and through the bread slices, thus extending the time where the sandwich remains palatable, and therefore one aspect of its shelf-life. Retorting alone might be expected to extend the time that the sandwich is free from bacteria (and thus technically edible) to a far greater amount of time than ‘fresh’ sandwiches. However, the palatability of the sandwich may suffer greatly after a shorter amount of time in sandwiches without a fat barrier as compared to those of the present invention containing a fat barrier. Thus, it is believed that the presence of the fat barrier in the sandwich of the present invention helps maintain the palatability of the sandwich for a greater amount of time than ‘fresh’ sandwiches, while still achieving a ‘near-fresh’ feeling product. Moreover, it has been found, surprisingly, that a fatty substance with as little as about 8% fat works effectively as a barrier. One would normally expect the need for a high fat content (e.g. significantly over 50%) to achieve an effective barrier to movement of the filling. Thus, the ‘fatty substance’ of the present invention may be considered to be a barrier substance, even though its fat content is relatively low.

Preferably, the fatty substance used in the present invention is a flowable fatty substance, meaning that it can be more easily applied, such as by spreading or spraying, on to the slice of bread. This allows for e.g. increased ease of spreading during the manufacture of the sandwich. Preferably the fatty substance is flowable at ambient temperature, although in some embodiments of the present invention the flowable character of a fatty substance is achieved by heating the fatty substance from ambient temperature to a sufficient temperature such that it becomes easier to spread. Specific examples of flowable fatty substances that can be used in the present invention are liquid cheese, butter, margarine, various mixes such as béchamel sauce etc. as long as they fulfil the fat content requirement of the present invention. Solid fatty substances that can be made flowable during the manufacturing process for ease of spreading are, for example, a variety of cheeses, such as Lancashire and cheddar, which can be heated to increase flowability.

In particular, and especially for savoury sandwiches, (liquid) cheese comprising at least about 8% fat and no more than about 16% fat can be spread on one side of each slice of bread. Optionally, and particularly although not exclusively for sweet sandwiches (i.e. those sandwiches containing a sweet filling), a margarine containing no more than about 16% fat may be used as the fatty spread.

The fatty substance of the present invention may be a combination of ingredients (e.g. 2, 3, 4, or more), which themselves have varying fat contents. The final fat content of the fatty substance for use in the present invention may be achieved in various ways. One example may be to use a cheese with, say, a higher-than-16% fat content (e.g. approx. 30%), and combine said cheese with e.g. a béchamel sauce such that the final fat content of the fatty substance as a whole is lowered from that of the cheese to, e.g. around 16% fat content.

Another feature of the sandwich of the present invention is that the application of the fatty substance to the inner slice(s) of bread followed by the bonding of the periphery of the bread is intended as an all-in-one system, wherein an additional sealant running around the periphery of the filling is not required to retain the contents of the sandwich.

A variety of fillings, both sweet and savoury, can be used in the sandwich of the present invention, such as protein based fillings (e.g. cheese, sliced meat such as ham, etc.), fruit or vegetable based fillings (e.g. beans, pickles, etc.), preserves (e.g. strawberry jam, raspberry jam, etc.), chocolate and nut based spreads, various sauces (e.g. tomato sauce, mayonnaise, béchamel, etc.), etc.. Moreover, flavourings, herbs, spices, etc. can be used as part of the filling. A combination of one or more types of filling can be used, such as two types of cheese (e.g. Lancashire and Country Farm), or cheese and beans, or ham and beans, or ham and cheese, etc. The person of skill in the art will appreciate that combinations of sandwich fillings may change due to particular tastes of the intended consumer, or due to trends in the consumer market. If a filling sauce is used, such as béchamel, then it is preferable that the sauce has a low moisture migration, low a_{w} (water activity), a strong flavour profile and withstands the retort process used in the manufacture of the product of the present invention.

Optionally, other additional ingredients may be added to the fillings, such as preservatives, flavour enhancers, colour, etc. Polyphosphates may optionally be added to the filling. For example, it has been found that with the use of some cheeses, better retort properties are achieved if polyphosphates are used as part of the filling.

The desired filling is added to one slice of bread, such that it is applied on top of the fatty spread that already has been added to the slice. Preferably, the filling is not applied to the complete surface of the bread, such that a margin that is substantially free of filling is left around the periphery of the bread slice. In a typical sandwich, preferably the filling is applied such that it stops about 1 cm away from all the edges of the bread.

After the required filling has been added, the sandwich is lidded. The slice of bread without the filling is laid on top of, and substantially in line with, the slice holding the filling such that the coated side is in contact with the filling.

After lidding the slices of the sandwich are sealed (e.g. bonded, crimped, etc.) together, effectively creating a pocket containing the filling which is therefore retained in place during the rest of the manufacture process and thereafter, during transport etc.

Particularly preferred methods of bonding the slices of the bread together in the present invention result in there being no or little constriction of the bread in the bonded region after the bonding step has been performed. In this regard, it is important for the appearance and texture of the sandwich to be pleasing to the end consumer, and as such it is preferred that the bonding step does not produce a significant difference in the density of the bread in and around the bonded region. In other words, it is preferred that the bonded region does not result in a hard rim of bread (relative to the rest of the bread) running around the periphery of the filling, which would be achieved with some forms of bonding such as pressure crimping and the like, which would be evident to the consumer. It is appreciated that there may be some subtle degree of density change in the bread, particularly at the bond surfaces, but this should not be significantly noticeable to the consumer. Another advantage of the methods of bonding in the present invention is that the bonded regions of the slices of bread do not look significantly different from the non-bonded regions of the bread.

In the present invention, the sandwich slices are bonded preferably using localised radio frequency welding. This may have the benefit of producing an aesthetically pleasing product and eliminating unappetising dense or rough regions around the edges of the bread. Localised radio frequency heating is known to the food industry, and it is typically used for heating, drying and defrosting of food.

The skilled person is well aware of radio frequency (RF) heating. Briefly, RF heating is a type of electro-heat technique. The principle behind the technique is that portions of the electromagnetic spectrum are utilised as the primary energy source to heat a material. The application of electromagnetic radiation may be direct (straight into the material) or indirect (via a heated appliance). This differs from conventional heating which is based on heat moving through the material.

There are two principal mechanisms by which a dielectric material can be heated by an RF electromagnetic-field: (1) Electrical conduction; and (2) Dipole rotation.

Heating through electrical conduction is where small currents are induced within the dielectric material by the oscillating electric-field dissipating power as heat in a process known as Joule heating.

Many dielectric materials have dipolar molecules. A common dipolar molecule in

RF heating applications, for example in the food or drying industries is water. Dipolar molecules within a dielectric material couple themselves electro-statically to the applied electromagnetic-field and tend to align themselves mechanically with the field polarisation. The applied electromagnetic-field is alternated in time and the dipoles attempt to realign themselves with the oscillating field, resulting in molecules which are in a state of mechanical oscillation at the applied frequency. The successive rotations generate heat through friction at the molecular level. When the applied field is removed, the dipolar molecules relax back into their original equilibrium state.

RF heating typically refers to heating in the 1-500 MHz frequency range. In RF heating applications the material is placed between a set of electrodes to which a high-voltage, typically in the kilovolt (kV) range, is applied at the appropriate frequency. This structure creates a capacitor where the material is part of the dielectric, and a charge and discharge current flows between the electrodes creating an alternating electric-field across the material.

A similar technique is employed in microwave heating, which typically refers to heating in the 0.5-3 GHz frequency range.

The completed sandwich is bonded in the edge region where the bread has been left free of filling using localised radio frequency welding. Preferably the bonding occurs around substantially all of the periphery of the bread between approximately 0.1 and 1 cm, preferably between about 0.2 and about 0.6 cm, from the edge of the bread. Preferably the slices of the bread are sealed such that there is no route of escape for the filling held within the slices. In this regard, the slices of bread are preferably completely bonded together. Typically the time taken to bond the slices of a sandwich of the present invention ranges from about 4 to about 30 seconds. Evidently, the bonding step is preferred to be as quick as possible, and as short a time that will allow sealing of substantially the entire periphery of the sandwich is preferred. The seal preferably takes between 10 to 20 seconds to achieve.

Other methods of bonding that can achieve a substantially total sealing of the filling within the sandwich may be used, such as heat pressing and the like.

Optionally, the sandwich can be lightly toasted after bonding the slices together. This produces an aesthetic product which can be presented in a pleasingly visual way to the consumer.

After the slices of the sandwich have been bonded, it is then placed in a container, such as a pouch or bag, and sealed. Such ‘bagging’ and sealing is standard in the art of packaging foodstuffs, and the skilled person will understand what to do and how to do it. Briefly, the sandwich is placed in a container (without compromising the bond of the bread) and the container is then sealed by standard means such as heat sealing, RF heating etc.

The container can be either a normal sealed pouch (where the pouch acts purely as a transport and/or storage mechanism and therefore may not be suitable for heating) or a pouch which is able to be heated (e.g. toastable). Appropriate containers that exist in either category are well known to the skilled person such as laminated barrier pouches or Toastabags®. The latter option may provide the most convenience to the consumer as there is no need to handle the sandwich to toast it if toasting is desired.

Once placed in a sealed pouch, the sandwich is retorted to sterilise it and ensure that the sandwich is fit for human consumption. Preferably, the resulting product has an ambient shelf life of up to 60 days.

The sealed pouch containing the sandwich is retorted under a suitably low (as compared to standard retort procedures) and optionally varying pressure to ensure that no squashing or crushing of the bread occurs, while also avoiding damage of the pouch due to its expansion from internal pressure changes during retorting. Under the same retort process applied to the sandwich, soup filled pouches with particulates have exploded. This is due to the internal pressure of the pouch building up during heating and exceeding the external pressure in the retort vessel and therefore rupturing the pouch in trying to achieve equilibrium.

The retorting phase of the present invention is considered to be particularly inventive. In some embodiments of the present invention, the retort process is used in the manufacture of a sandwich of the present invention. However, the recited retort process is not so limited to such a use, and in other embodiments of the present invention the retort process can be used for any product which could undergo retorting. It is envisaged that products which are required to be aesthetically pleasing to the consumer particularly will benefit from the present retort process. In this regard, the skilled person is aware that retorting is a food processing method normally used for cans, glass jars, trays and pouches, where the food is first packaged, and then heated at high temperature in a retort sterilizer to sterilize it. In this operation, strict specifications, concerning both time and temperature, must be adhered to and repeated, batch after batch, to obtain sterile product and uniform quality.

Typically, retorting is achieved by steam, raining or spray water or full water immersion with overpressure from compressed air.

In canning most production is processed in continuous steam vessels, reel and spiral or hydrostatic type where the can enters the saturated pressurised steam environment through a valve or water seal and is held (and agitated in reel and spiral vessels) for the required duration of time before it exits through another valve or water seal into a pressurised water cooling environment.

In glass processing jars typically are processed through either raining water pasteurisation tunnels at environment pressure or in batch overpressure retorts where higher temperatures can be achieved in addition to pressures above environment pressure and the pressure naturally achieved in a steam environment at a given temperature.

Typically retorts used for processing glass are of the raining or spray water type but in principle steam/air overpressure retorts can also be used for this type of packaging.

In pouch processing overpressure retorts of the steam/air, raining or spray water or full water immersion types are all commonly used.

With any modern batch overpressure retort the sequence is usually as follows:
1 Load retort with product.
2 Close door and engage safety interlock
3 Start retort sequence on controller. This will run the retort through a predetermined process sequence, as an example
   A Vent (though not all modern overpressure batch systems require venting)
   B Heat to predetermined cooking temperature/pressure over a pre determined period of time
   C Cook for a pre determined period of time at a pre determined pressure
   D Cool to a pre determined temperature using a pre determined pressure decrease over a pre determined period of time

In a typical pouch retort process, processing a liquid product, in a modern batch retort of any type, the pouch deflection is very well restrained with overpressure throughout the process.

Pressure control on all modern overpressure retorts needs to be very accurate, typically within +/−50 mb, though with certain types of packaging including the pouch used in this application the tolerances need to be reduced to +/−25 mb.

The cook period (hold' or ‘sterilisation’ phase) is essential in order to cook the product thoroughly, thereby destroying any organisms that could later spoil it. These organisms, in particular fungal spores and Clostridium botulinum, are able to withstand several hours of atmospheric boiling water temperature, but are destroyed in a short time at a temperature of 116 to 121° C. (240 to 250° F.).

After the cook period, the retort pressure, attained as a result of cooking at high temperature in a closed vessel, must be relieved before the product can be removed safely. Depending on what is being retorted, e.g. if the retort has been filled with small cans, the pressure can be reduced to atmospheric immediately in a process commonly known as blowdown. However, if the retort contains other products, such as large cans, it is necessary to lower their internal pressure before blowdown takes place to prevent them from exploding or distorting. The reduction of internal can pressure is obtained by circulating cooling water through the retort whilst maintaining retort pressure at the value attained during cooking by introducing pressurizing air. When the product internal pressure has dropped to a safe value, typically indicated by the temperature of the cooling water leaving the retort dropping to a desired value, blowdown can take place without the threat of damage to the product. All containers now require pressurisation in early stages of cooling.

Thereafter there is typically a water cooling period for the retorted product. This may be achieved by removing the product from the retort immediately after blowdown and immersion in a cooling canal. Alternatively, the product, after cooling in the retort, may require further cooling in the same manner.

In the present invention, it is preferred to use a steam/air retort process, although a raining water retort process can also be employed. However, the present inventors have discovered that using standard settings of a retort process typically used for pouched products resulted in flattening and damage of the sandwich in light of the high pressure that is achieved during the cooking step, and also damage to the sandwich during the cooling phase as the internal pressure of the pouch is overwhelmed by the pressure in the retort vessel. As shown in FIG. 1, a typical pressure achieved during a standard pouch retort process can be between about 2 and about 2.5 barg. This is typically maintained for a time after the cooking (sterilisation) step has been completed and the temperature begins to decrease. The high retort pressure is generally not an issue when retorting e.g. pouches containing liquid products such as soup, since liquid is relatively non-compressible. Moreover, the aesthetic value of such products is generally not an issue. It is safer, therefore, to have a high pressure in the retort to prevent the internal pressure of the pouch which results from the heating step from exploding the pouch. However, with the sandwich of the present invention, damage to the product is not desired, since the sandwich must be aesthetically pleasing when viewed by the customer. Unlike liquids, the nature of bread lends itself to being relatively compressible and therefore susceptible to damage by high pressures.

Thus, in order to prevent damage to the sandwich, the present inventors surprisingly have found that using lower pressures as compared to standard retort processing, and having a more controlled variance of the pressure during each of the retort steps, can achieve the desired result.

In this regard, the retort process of the present invention can employ an optional longer heating (come up) phase towards the cooking (sterilisation or hold) phase to create a gradual internal pressure rise in the pouch.

This is followed by reduced pressure (as compared to standard retort) in the hold phase at the process temperature. The combination of these variables allows the pouch (in embodiments of the invention where a pouch is used) to expand slightly during processing without allowing it to stretch and destroy any barrier properties.

At the end of the sterilisation phase, as the temperature in the retort vessel drops, the pressure in the vessel is adjusted to drop in a corresponding manner. Such pressure and temperature drops are controlled so that they follow a gradual reduction from the cooking parameters back to a normal (non-retort) state. By this it is meant that there are no significant ‘spikes’ in the variance of the pressure or temperature during the come-down stage. In the present invention, a typical ‘gradual’ decrease in pressure is one where the pressure decreases on average at a rate of approximately 0.05 barg per minute (approx. 0.25 barg per 5 mins, approx. 0.5 barg per 10 mins). Such an average decrease can be made of different phases of decrease, such that a slightly faster rate of decrease of e.g.

about 0.1 to about 0.08 barg per minute (approx. 0.4 to approx. 0.5 barg per 5 mins, approx. 1 to approx 0.8 barg per 10 mins) may be maintained for a short amount of time (e.g. about 10 to 15 minutes), followed by a less pronounced rate of decrease such as e.g. about 0.06 barg per minute (approx. 0.3 barg per 5 mins, 0.6 barg per 10 mins) for another period of time (e.g. about 10 minutes). A typical ‘gradual’ decrease in temperature is one where the temperature decreases relatively slowly at first (e.g. at a rate of about 2.6° C. per minute (approx. 13° C. per 5 mins, approx. 26° C. per 10 mins) for about 10 minutes) and then optionally may increase the rate of decrease to e.g. about 5 to 6° C. per minute (approx. 25 to 30° C. per 5 mins) for a further approx. 10 minutes). This prevents the vessel pressure from being significantly larger than the dropping pressure within the pouch as the product cools and so crushing the sandwich (or other item that is the subject of the retort).

With regard to the temperatures during the various phases of the present retort process, the heating during the come up phase is increased gradually and constantly almost immediately from the start of the process, preferably within a few minutes (e.g. about 1, about 2, about 3, about 4 minutes) from the start of the process, such that there is reasonably constant heating over e.g. an initial 20 minutes or so of the retort to the cooking temperature. By a gradual increase it is meant that there are no significant ‘spikes’ in the temperature (where the temperature might increase by a large amount over a short amount of time) from the start of the process. In the present invention, a typical ‘gradual’ increase in temperature may average approx. 6° C. per minute for approx about 20 minutes. There may be different phases of temperature increases which result in the average increase, such as an initial increase in temperature of approx. 10° C. per minute for approx. 10 minutes, followed by a slower increase in temperature of approx. 2° C. per minute for approx. 10 minutes before the sterilisation phase commences.

After a time (e.g. about 50 minutes or so) in the cooking phase (industry standard temperatures are in the region of approx 120° C.), there follows a gradual decrease in temperature, such that it takes approximately 10 minutes to reduce the temperature from the cooking temperature to approx. 95° C. Thereafter, it takes a further approx. 10 minutes to reduce the temperature to approx 40° C., and finally a further 10 minutes to achieve ambient temperature.

In alternative embodiments of the present invention, retorting the product at a lower cooking temperature for a longer period of time is possible, or retorting the product at a higher cooking temperature for a shorter period of time. In this regard, the lower limit of the temperature may be e.g.110° C. held for a longer time period. Alternatively, there may be processes employed which hold the temperature at approx. 115° C. for double the length of time of a sterilising step carried out at approx. 120° C. (i.e. approx. 100 minutes), or even up to approx. 125 to 130° C. for a reduced time (25% and 50% reduction in time, such as approx. 37.5 mins to 25 mins, respectively).

The retort phase of the present invention preferably employs a maximum pressure of below about 2 barg. More preferably, the retort process of the present invention employs a pressure of between atmospheric pressure and about 1.8 barg. Preferably the cooking pressure of the present retort process employs a pressure of between approx 1 and 1.8 barg. Preferably, the maximum pressure achieved is approximately 1.5, 1.6, 1.7 or 1.8 barg. The raising of the pressure at the start of the process and the reduction of pressure after the cooking phase is carried out in a gradual manner so as not to affect the integrity of the sandwich or its pouch (or other item undergoing retort). Typically there is a delay between the commencement of the increase in temperature and that of the increase in pressure, such that the pressure of the vessel is only increased when the internal pressure of the pouch (in light of the increasing heat within the pouch) becomes enough to counter the crushing effect of the vessel pressure on the sandwich (or other item). Such a delay may be in the range of between about 0 and about 15 minutes, preferably between about 5 and about 14 minutes, preferably between about 8 and 13 minutes, preferably between about 9 and about 11 minutes, and in some embodiments about 11 minutes. Once the increase in pressure is commenced, the gradual increase may be conducted at a rate of approx. 0.1 to approx. 0.2 barg per minute (approx. 0.5 to approx. 1 barg per 5 mins, approx. 1 to approx. 2 barg per 10 mins), preferably approx. 0.12 to 0.15 barg per minute (approx. 0.6 to 0.75 barg per 5 mins, approx. 1.2 to approx 1.5 barg per 10 mins), preferably approx 0.13 barg per minute (approx. 0.65 barg per 5 mins, approx. 1.3 barg per 10 mins) to the beginning pressure of the sterilisation phase.

In alternative embodiments, the pressure of the vessel can be increased even more gradually from approximately the same time as the temperature is increased (e.g. approx. 0.05 to 0.07 barg per minute (approx. 0.25 to 0.35 barg per 5 mins, approx. 0.5 to 0.7 barg per 10 mins) for approx. 20 minutes), as long as there is a balance between the increasing temperature and pressure such that crushing of the sandwich/exploding of the pouch (or other item undergoing retort) is avoided.

In the present invention, when discussing the commencement of the retort process, it is intended to mean the commencement of the first heating phase of the process, rather than e.g. loading the vessels into the retort etc.

The pressure is held approximately over the time of the cooking phase. Evidently there may be variations in the pressure achieved over the cooking phase, and it may be adjusted during the cooking phase in order not to compromise the integrity of the sandwich/pouch. There may be a gradual increase in pressure over a substantial time period of the cooking phase, which may be required to counteract any increasing pressure within the pouch (or other container) as the cooking phase progresses.

In embodiments of the present invention, the pressure may increase approximately gradually from a pressure of about 1.3 barg at the start of the cooking phase to a pressure of about 1.6 barg at the end of the cooking phase.

In preferred embodiments, the pressure in the vessel is gradually increased to the pressure achieved during sterilization over a period of approx. 10 minutes. At the end of the sterilization phase, there is a gradual reduction immediately, or almost immediately, on commencement of the cool-down phase over a period of approx 30 minutes to ambient pressure.

After the retort process, the product is able to be stored in ambient conditions for an extended period of time. This is preferably up to 60 days, although it may be longer.

Finally, to ensure that the product is consumed under the best possible conditions, the consumer is advised to toast the sandwich in a conventional toaster for approximately 3 minutes.

### EXAMPLE 1

### Savoury Sandwich: Ham, Cheese, Beans

A savoury-filled sandwich according to the present invention was made. Two slices of standard white bread were obtained and each was fully coated (as ascertained by brief visual inspection) on one side with a 16% fat liquid cheese.

The fillings comprised:

1) cheese comprising a combination of 50% Lancashire grated cheese (16% fat) and 50% Country Farm grated cheese (16% fat);

2) cheese flavoured béchamel pre mix with dairy and non dairy components separate (sourced from Synergy Ltd.). The cheese flavoured béchamel consists of béchamel sauce mix, starch, polyphosphate—Joha s9, cheese stock paste, liquid blue cheese booster and powder blue cheese booster;

3) ham; and optionally

4) baked beans.

### EXAMPLE 2

### Sweet Sandwich: Jam

A sandwich was made by first coating one side each of two slices of bread with margarine (according to the parameters of the present invention) and then adding strawberry jam as a filling.

### EXAMPLE 3

### Lidding and Bonding

The sandwiches as described in Examples 1 and 2 were closed with the slice of bread not holding the filling, and bonded in the edge region using RF heating (devices supplied by Petrie Ltd.) for between 10 and 20 seconds.

This process gave a seamless and solid bond around the periphery of the sandwich.

### EXAMPLE 4

### Packing

The sealed sandwich was placed in a standard laminated barrier retortable pouch which was heat-sealed using identical partial vacuum 750 mb abs.

### EXAMPLE 5

### Retorting

The packed sandwich as obtained in Example 4 then underwent a retort process of steam/air using a Lagarde steam/air retort. The timings are outlined in Table 1 below.

TABLE 1
Steam/Air Retort Process

| | | | | Pressure | |
|---|---|---|---|---|---|
| | | | | (bar above | |
| | | Time | Temperature | atmospheric | |
| Segment | Step | (mins) | (° C.) | [barg] | Rotation |
| Start | 0 | 0 | 25 | 0.1 | 0 |
| Venting | 1 | 2 | 40 | 0.1 | 0 |
| Venting | 2 | 8 | 100 | 0.1 | 0 |
| Heating | 3 | 10 | 121.1 | 1.3 | 0 |
| Sterilisation | 4 | 50 | 121.1 | 1.6 | 0 |
| Precool | 5 | 10 | 95 | 0.8 | 0 |
| Cooling | 6 | 10 | 40 | 0.2 | 0 |
| Cooling | 7 | 10 | 30 | 0 | 0 |
| Cooling | 8 | 15 | 30 | 0 | 0 |
| | Total | 105 | | | |

The sterilisation temperature is relatively standard in that it is required in order to kill bacteria and spores. However, the heating period up to the sterilisation phase is more gradual than standard procedures. Moreover, the peak pressure is much lower than standard retort procedures. Using these retort parameters, it was found that the sandwiches of Example 4 were not damaged and resulted in an aesthetically pleasing product for the customer. Moreover, the seal of the pouch was not compromised during the retort, thus providing for a suitable container for long life storage in ambient conditions. Pouch barrier properties were also intact.

### EXAMPLE 6

### Shelf Life

It was found that the best performance of the product is to consume within 60 days of manufacture. The product was still safe for human consumption after this time, but it was found that the sandwich becomes very dry and the fillings merged together and therefore are not very palatable.

Although the present invention has been described with reference to specific embodiments, the person of skill in the art will appreciate that there may be alternative embodiments that are not described in detail herein but which fall within the scope of the present invention.

Again, although the present invention has been described with reference to being a sandwich, the foodstuff described is suitable for any meal occasion and not just those normally associated with sandwiches, such as lunch or tea.

1. A process of making a sandwich, said process comprising the steps of:
applying a fatty substance containing between about 4% to about 30% fat content, preferably between about 8 to about 16% fat content, preferably about 16% fat content to at least one side of a slice of bread, wherein the fatty substance is applied to substantially all of the region of bread that will be in contact with a filling;
applying said filling on top of the fatty substance;
lidding the filling with a second region of bread, wherein said second region of bread also has applied to it said fatty substance; and
bonding the regions of bread together to form a seal.

2. The process of claim 1 further comprising:
optionally lightly toasting said sandwich;
packaging said sandwich in a container and sealing said container; and
retorting said packaged sandwich.

3. The process of claim 1, wherein fresh bread is used to manufacture the sandwich.

4. The process of claim 3, wherein the bread has not been frozen prior to making the sandwich.

5. The process of claim 1, wherein said fatty substance contains about 16% fat.

6. The process of claim 1, wherein the fatty substance is a liquid cheese or margarine.

7. The process of claim 1, wherein the fatty substance comprises a combination of ingredients each having a differing fat content, such as cheese and a bechamel sauce, optionally where one of the ingredients can contain zero fat.

8. The process of claim 1, wherein said step of bonding the regions of bread together is carried out using localised radio frequency heating.

9. The process of claim 8, wherein the bond forms a seal around substantially all of the outer region (periphery) of the pieces of bread.

10. The process of claim 2, wherein said container is a toastable container.

11. The process of claim 2, wherein said step of retorting the packaged sandwich is carried out at a pressure of less than about 2 barg, preferably wherein said pressure does not exceed about 2 barg during substantially the duration of the retort, preferably the whole duration of the retort.

12. The process of claim 11, wherein said pressure during the retort sterilisation phase is optionally a varying pressure, ranging from about 1 barg to about 2 barg, preferably from about 1.3 barg to about 1.8 barg, preferably from about 1.3 barg to about 1.6 barg.

13. The process of claim 1, wherein the pressure in the come up phase and cooling phase of said retort is varied gradually to prevent damage to said sandwich or sealed package.

14. The process of claim 13, wherein the pressure is gradually increased to the pressure achieved during sterilization at an average rate of approximately 0.1 to approx. 0.2 barg per minute (approx. 1 to approx. 2 barg per 10 mins), preferably approx. 0.12 to 0.15 barg per minute (approx. 1.2 to 1.5 barg per 10 mins), preferably approx 0.13 barg per minute (approx. 1.3 barg per 10 mins), and/or wherein there begins an immediate gradual reduction in pressure at the end of the sterilization phase at an average rate of approximately 0.05 barg per minute (approx. 0.5 barg per 10 mins) over a period of approx 30 minutes to ambient pressure.

15. The process of claim 13, wherein the temperature in the come up phase is gradually and steadily increased to sterilisation temperature from about immediately from the commencement of the first heating phase of the retort process, optionally at an average rate of approx. 6° C. per minute for about 20 minutes.

16. The process of claim 13, wherein the temperature in the cooling phase is gradually and steadily decreased with a concurrent gradual and steady reduction in the pressure in the retort vessel.

17. The process of claim 13, wherein the pressure during the retort starts to increase from approximately 8 to 13 minutes after the temperature begins to increase, preferably about 9 to 11 minutes after the temperature begins to increase.

18. The process of claim 13, wherein said temperature profile of the retort is controlled to prevent damage to the sandwich and/or package, preferably wherein the temperature during the come up phase is increased from ambient to sterilisation temperature over a period of about 20 minutes, with temperature rising continuously during this phase.

19. A packaged sandwich as produced according to the process of claim 1.

20. A sandwich comprising:
at least two regions of bread which encompass at least one filling, each region having a side which faces said filling and a side which does not face said filling;
the sides of the regions of bread which face said filling having incorporated thereon a fatty substance; and
wherein the fatty substance has between about 4% to about 30% fat content, preferably between about 8 to about 16% fat content, preferably about 16% fat content,
and wherein at least a portion of each of the regions of bread is bonded together to prevent the filling from escaping.

21. The sandwich of claim 20, wherein the sandwich does not contain a distinct additional ingredient that is added specifically to either or both regions of the bread in order to assist bonding of the regions of bread together.

22. The sandwich of claim 20, wherein the bread is sandwich bread.

23. The sandwich of claim 20, wherein the fatty substance comprises liquid cheese.

24. The sandwich of claim 20, wherein the fatty substance comprises margarine.

25. The sandwich of claim 20, wherein the fatty substance comprises a combination of ingredients each having a differing fat content, such as cheese and a bechamel sauce, optionally where one of the ingredients can contain zero fat.

26. The sandwich of claim 20, wherein the fat content of the fatty substance is about 16%.

27. The sandwich of claim 20, wherein the fatty substance is delivered to substantially all of the side of the regions of bread which face the filling.

28. The sandwich of claim 20, wherein the bonding of the regions of bread is completed around substantially all of the periphery of the bread.

29. The sandwich of claim 28, wherein the bonding is completed around the entire periphery of the bread.

30. The sandwich of claim 20, wherein the bonding of the regions of bread is carried out by radio frequency (RF) heat bonding, thereby resulting in an RF heat bond.

31. The sandwich of claim 20, wherein the bread used to make the sandwich is fresh at the time of manufacture, preferably wherein it has not previously been frozen.

32. The sandwich of 20, wherein the sandwich is lightly toasted.

33. The sandwich of claims 20 to 32, which is contained within a sealed container.

34. The sandwich of claim 33, wherein the sealed container is a toastable pouch.

35. The sandwich of claim 33, wherein said sandwich has been subjected to retort whilst in said sealed container.

36. The sandwich of claim 20, wherein the sandwich is palatable at 60 days post-manufacture.
